(19) United States
(12) Patent Application Publication
(10) Pub. No.: US 2020/0065713 A1
(43) Pub. Date: Feb. 27, 2020

(54) Survival Analysis Based Classification Systems for Predicting User Actions

(71) Applicant: Adobe Inc., San Jose, CA (US)

(72) Inventors: Xiang Wu, Mountain View, CA (US); Zhenyu Yan, Cupertino, CA (US); Yi-Hong Kuo, Sunnyvale, CA (US); Wuyang Dai, San Jose, CA (US); Julia Viladomat Comerma, Palo Alto, CA (US); Abhishek Pani, San Francisco, CA (US)

(73) Assignee: Adobe Inc., San Jose, CA (US)

(21) Appl. No.: 16/112,546

(22) Filed: Aug. 24, 2018

(51) Int. Cl. G06N 99/00

(52) U.S. Cl. CPC G06N 99/005

(57) ABSTRACT

Techniques and systems are described that employ survival analysis and classification to predict occurrence of future events by a digital analytics system. Survival analysis involves modeling time to event data. Survival analysis is used by digital analytics systems to analyze an expected duration of time until an event happens. In the techniques described herein, survival analysis is employed as part of a classification technique by a digital analytics system. In one example, a digital analytics system generates training data from a dataset in accordance with a survival analysis technique such that, after generated, the training data is usable to train a classification model.

### BACKGROUND

Digital analytics systems are implemented to analyze “big data” (e.g., Petabytes of data) to gain insights that are not possible to obtain, solely, by human users. In one such example, digital analytics systems are configured to analyze big data to predict occurrence of future events, which may support a wide variety of functionality. Prediction of future events, for instance, may be used to determine when a machine failure is likely to occur, improve operational efficiency of devices to address occurrences of events (e.g., to address spikes in resource usage), resource allocation, and so forth.

In other examples, this may be used to predict events involving user actions. Accurate prediction of user actions may be used to manage provision of digital content and resource allocation by service provide systems and thus improve operation of devices and systems that leverage these predictions. Examples of techniques that leverage prediction of user interactions include recommendation systems, digital marketing systems (e.g., to cause conversion of a good or service), systems that rely on a user propensity to purchase or cancel a contract relating to a subscription, likelihood of downloading an application, signing up for an email, and so forth. Thus, prediction of future events may be used by a wide variety of service provider systems for personalization, customer relation/success management (CRM/CSM), and so forth.

Conventional techniques used by digital analytics systems to predict occurrence of future events, however, are faced with numerous challenges that limit accuracy of the predictions as well as involve inefficient use of computation resources. In one example, accuracy of conventional techniques is limited by a number of observations of user actions that are available to generate a model to predict future actions. Conventional techniques, for instance, are typically limited to a single observation per user, and thus historical information regarding the user is lost in determining what causes that action. Therefore, these conventional techniques have limited accuracy and result in efficient use of computational resources by systems that employ these conventional techniques.

### SUMMARY

Techniques and systems are described that employ survival analysis and classification to predict occurrence of future events by a digital analytics system. Survival analysis involves modeling time to event data. Survival analysis is used by digital analytics systems to analyze an expected duration of time until an event happens. In the techniques described herein, survival analysis is employed as part of a classification technique by a digital analytics system. As a result, survival analysis may be used by a digital analytics system to address a wide range of “big data” and models that are not possible in conventional survival analysis techniques. Further, these techniques may be generalized to a wide range of events that are not capable of being addressed by conventional survival analysis techniques.

In one example, a digital analytics system generates training data from a dataset in accordance with a survival analysis technique such that, after generated, the training data is usable to train a classification model. In this way, the digital analytics system is able to leverage survival analysis as part of classification to address “big data” that otherwise would not be possible in conventional techniques. To do so, the digital analytics system generates a plurality of observations for each entity in the dataset over time, and thus provides richer training data over conventional techniques that are limited to single observations per entity.

The training data is then used as a basis to train a classification model. Different types of classification models may be trained, including statistical models and machine learning models. Classification models are used by the digital analytics system to classify an observation into a particular category. As part of leveraging survival analysis, this may be used to classify a subsequent observation into category specifying that an event will occur or another category specifying that an event will not occur. In this way, the classification model may predict occurrence of an event and may do so leveraging the rich training data with improved accuracy through training of the classification model using observations generated over time using survival analysis.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ survival analysis and classification techniques described herein.

FIG. 2 depicts a system in an example implementation showing operation of a survival analysis module and classification module of a digital analytics system of FIG. 1 in greater detail as generating training data to train a classification module.

FIG. 3 depicts an example implementation of generation of training data as a plurality of observations using a survival analysis technique of the survival analysis module of FIG. 2.

FIG. 4 depicts a system in an example implementation in which the training data generated by the system of FIG. 2 using survival analysis is used to train a classification model to classify a subsequent observation into a respective one of a plurality of categories as predicting occurrence of an event.

FIG. 5 is a flow diagram depicting a procedure in an example implementation in which a survival analysis technique is used to generate a plurality of observations which are then used to train a classification module to classify a subsequent observation to a respective one of a plurality of categories.

FIG. 6 illustrates an example system including various components of an example device that can be implemented as any type of computing device as described and/or utilize with reference to FIGS. 1-5 to implement embodiments of the techniques described herein.

### DETAILED DESCRIPTION

Overview

Prediction of occurrence of future events is used to support a wide range of functionality, from device management, control of digital content to users, and so forth. Conventional techniques to do so, however, have limited accuracy due to the lack of training data used to train models that serve as a basis to make the predictions. Accordingly, service provider systems that employ these conventional techniques are confronted with inefficient use of computational resource to address these inaccuracies. For example, accuracy in prediction of events involving computational resource usage by a service provide system may result in outages in instances in which a spike in usage is not accurately predicted or over allocation of resources in instances in which a spike in usage is predicted but does not actually occur. Similar inefficiencies may be experienced in systems that relay on predicting events involving user actions, e.g., churn, upselling, conversion, and so forth.

Accordingly, techniques and systems are described that employ survival analysis and classification to predict occurrence of future events by a digital analytics system. Survival analysis involves modeling time to event data. Survival analysis is used by digital analytics systems to analyze an expected duration of time until an event happens, such as death of an entity and hence the origin of the “survival” aspect of its name. In initial survival analysis techniques, the event is death of an organism (e.g., for life tables used in setting rates for life insurance), and thus each organism is conventionally limited to a single occurrence of the event in survival analysis. Conventional survival analysis techniques, however, while typically working well for small amounts of data fail when confronted with “big data” having a multitude of observations and thus covariates that are to be examined as a basis to form the prediction. Also, conventional survival analysis techniques have limited flexibility to address different types of data or models of the data.

In the techniques described herein, survival analysis is employed as part of a classification technique by a digital analytics system. As a result, survival analysis may be used by a digital analytics system to address a wide range of “big data” and models that are not possible in conventional survival analysis techniques. Further, these techniques may be generalized to a wide range of events that are not capable of being addressed by conventional survival analysis techniques.

In one example, the digital analytics system begins by receiving a dataset. The dataset may describe occurrence of events over time with respect to a variety of entities. The entities, for instance, may correspond to devices and the events may include failure of the devices, amounts of resource usage of the devices, and so forth. In another instance, the entities correspond to respective users of a multitude of users. As such, the events that correspond to the users may include a wide range of user actions, such as conversion, churn, purchase or termination of a subscription, upsell, and so forth. The dataset may also describe characteristics of the entities and/or actions over time, e.g., demographics, other types of actions or events performed by the entities that are monitored over time, user interactions with digital content, and so forth.

The digital analytics system generates training data from the dataset in accordance with a survival analysis technique such that, after generated, the training data is usable to train a classification model. In this way, the digital analytics system is able to leverage survival analysis as part of classification to address “big data” that otherwise would not be possible in conventional survival analysis techniques.

To do so, the digital analytics system generates a plurality of observations for each entity in the dataset over time. This provides richer training data over conventional techniques that are limited to single observations per entity. The digital analytics system, for instance, may begin by identifying a subset of the dataset that corresponds to an entity from a plurality of entities in the dataset. For example, the digital analytics system may select an Entity ID (e.g., User ID) from the dataset and locate a subset of the dataset that is associated with that Entity ID.

An observation time is then set with respect to the subset. The observation time defines an outcome window and a feature window within the subset that serves as a basis to generate the observation. The outcome window, for instance, may specify an amount of time (e.g., seconds, minutes, days, years, etc.) as a “width” of the window to be analyzed within the dataset. A user, for instance, may wish to determine whether an event will occur within sixty days and thus set a “width” of the outcome window to sixty days.

The feature window is defined between an initial point in time in the subset and the observation time. Thus, the feature window defines “what has happened” in the subset before the outcome window being analyzed. In order to generate the observation, the digital analytics system specifies a first term describing whether the event occurred in the outcome window and a second term describing the data included in the feature window for the subset.

The digital analytics system then generates additional observations from a by shifting the observation time. To do so, the digital analytics system shifts an observation time by a sliding interval, e.g., an amount of time at least equal to an amount of time of the outcome window. This shift in the digital analytics systems causes the outcome window and the feature window to be redefined. As a result, another observation may be generated that also includes a first term describing whether the event occurred in the outcome window and a second term describing the data included in the feature window for the subset. This technique may repeat by the digital analytics service through the subset, which is then repeated for additional entities included in the dataset.

The training data is then used as a basis to train a classification model. Classification models are used by the digital analytics system to classify an observation into a particular category. As part of leveraging survival analysis, this may be used to classify a subsequent observation into category specifying that an event will occur or another category specifying that an event will not occur. In this way, the classification model may predict occurrence of an event and may do so leveraging the rich training data with improved accuracy through training of the classification model using observations generated over time using survival analysis. Different types of classification models may be trained, including statistical models and machine learning models. Consequently, the survival analysis and classification techniques may leverage a wide range of classification models available to the digital analytics system and support survival analysis in “big data” that is not possible in conventional techniques.

### Term Examples

“Survival analysis” involves modeling time to event data. Survival analysis is typically used by digital analytics systems to analyze an expected duration of time until an event happens, such as death of an entity.

An “event” is a response or action of interest, occurrence of which, is to be predicted.

An “observation time” is a time in a dataset for a particular entity that is being observed. The observation time is used to define a portion of a dataset that is to serve as a basis for an observation for the particular entity.

A “feature window” is a window defined from a start time in a dataset to the observation time, within which, the features (explanatory variables) are generated for an observation. In other words, the feature window defines the data in a dataset that is available for an entity before the observation time that is usable to generate features that are a basis of the observations.

An “outcome window” is a window, within which, occurrence of the event is monitored. This window is used to generate a response variable for an observation. The outcome window defines a fixed amount of time after the observation time. The width (i.e., amount of time) may be predefined, e.g., based on how far into the future the event is to be predicted. For example, the outcome window may be set to thirty days to predict whether an event is to occur within the next thirty days.

A “sliding interval” is an interval specifying a predefined amount of time used to shift the observation time in order to generate the observations. In one example, an amount of time specified by the sliding interval is the same or bigger an amount of time specified by the outcome window.

In the following discussion, an example environment is first described that may employ the techniques described herein. Example procedures and techniques are then described which may be performed in the example environment as well as other environments. Consequently, performance of the example procedures is not limited to the example environment and the example environment is not limited to performance of the example procedures.

Example Environment

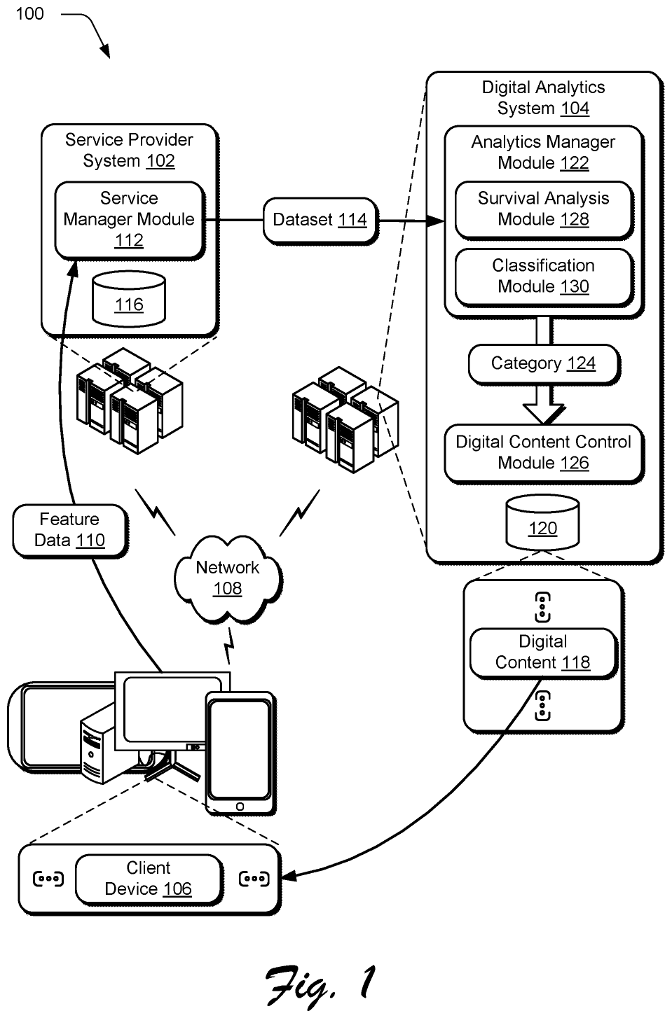

FIG. 1 is an illustration of a digital medium environment 100 in an example implementation that is operable to employ survival analysis and classification techniques in a digital analytics system as described herein. The illustrated environment 100 includes a service provider system 102, a digital analytics system 104, and a plurality of client devices, an example of which is illustrated as client device 106. In this example, events are described involving user actions performed through interaction with client devices 106. Other types of events are also contemplated, including device events (e.g., failure, resource usage), and so forth that are achieved without user interaction. These devices are communicatively coupled, one to another, via a network 108 and may be implemented by a computing device that may assume a wide variety of configurations.

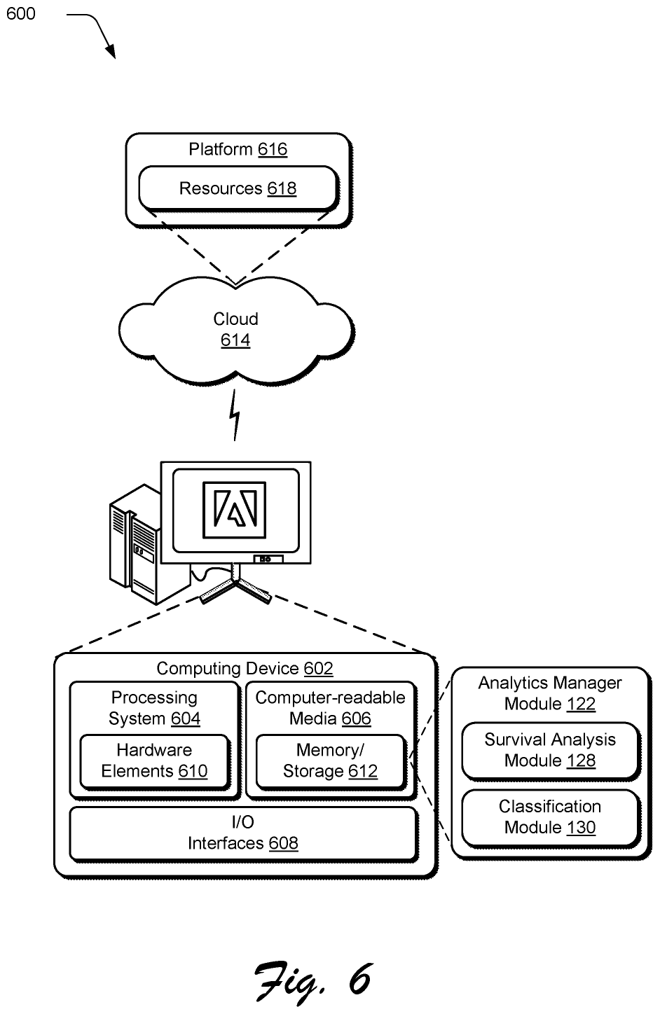

A computing device, for instance, may be configured as a desktop computer, a laptop computer, a mobile device (e.g., assuming a handheld configuration such as a tablet or mobile phone), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is shown, a computing device may be representative of a plurality of different devices, such as multiple servers utilized by a business to perform operations “over the cloud” as shown for the service provider system 102 and the digital analytics system 104 and as further described in FIG. 6.

The client device 106 is illustrated as engaging in user interaction with a service manager module 112 of the service provider system 102. As part of this user interaction, feature data 110 is generated. The feature data 110 describes characteristics of the user interaction in this example, such as demographics of the client device 106 and/or user of the client device 106, network 108, events, locations, and so forth. The service provider system 102, for instance, may be configured to support user interaction with digital content 118. A dataset 114 is then generated (e.g., by the service manager module 112) that describes this user interaction, characteristics of the user interaction, the feature data 110, and so forth, which may be stored in a storage device 116.

Digital content 118 may take a variety of forms and thus user interaction and associated events with the digital content 118 may also take a variety of forms in this example. A user of the client device 106, for instance, may read an article of digital content 118, view a digital video, listen to digital music, view posts and messages on a social network system, subscribe or unsubscribe, purchase an application, and so forth. In another example, the digital content 118 is configured as digital marketing content to cause conversion of a good or service, e.g., by “clicking” an ad, purchase of the good or service, and so forth. Digital marketing content may also take a variety of forms, such as electronic messages, email, banner ads, posts, articles, blogs, and so forth. Accordingly, digital marketing content is typically employed to raise awareness and conversion of the good or service corresponding to the content. In another example, user interaction and thus generation of the dataset 114 may also occur locally on the client device 106.

The dataset 114 is received by the digital analytics system 104, which in the illustrated example employs this data to control output of the digital content 118 to the client device 106. To do so, an analytics manager module 122 generates an indication of a category 124 configured to control which items of the digital content 118 are output to the client device 106, e.g., directly via the network 108 or indirectly via the service provider system 102, by the digital content control module 126. The category 124, for instance, may be used to predict occurrence of an event (e.g., whether or not the event will occur within a corresponding period of time) based on an observation obtained from the client device 106.

The category 124, for instance, may be configured to specify whether the client device 106 is likely to purchase or cancel a subscription. The category 124 may then be used by the digital content control module 126 to control output of digital content 118 to the client device 106. This may include use of digital content 118 to encourage a user of the client device 106 to purchase the subscription and/or convince the user to retain and not cancel a subscription through use of digital marketing content. Although the digital content 118 is illustrated as maintained in the storage device 120 by the digital analytics system 104, this digital content 118 may also be maintained and managed by the service provider system 102, the client device 106, and so forth.

To generate this prediction of occurrence of an event, the analytics manager module 122 includes a survival analysis module 128 and a classification module 130. The survival analysis module 128 is representative of functionality to implement a survival analysis technique. Survival analysis involves modeling time to event data to analyze an expected duration of time until occurrence of an event. Conventional survival analysis techniques, however, fail when confronted with “big data” having a multitude of observations and thus covariates that are to be examined as a basis to form the prediction. Also, conventional survival analysis techniques have limited flexibility to address different types of data or models of the data.

Accordingly, in the techniques described herein a survival analysis technique as implemented by the survival analysis module 128 is incorporated as part of a classification technique as implemented by a classification module 130 such that survival analysis may address “big data,” which is not possible in conventional techniques. Further, these techniques may be generalized to a wide range of events that are not capable of being addressed by conventional survival analysis techniques. To do so, survival analysis techniques of the survival analysis module 128 are used to generate training data having a plurality of observations over time from the dataset 114 between an initial point in time in the dataset 114 and occurrence of an event by a respective entity.

The training data is then used by a classification module 130 to train a classification model using statistical or machine learning techniques. The classification model, once trained, is employed by the analytics manager module 122 to categorize a subsequent observation into a respective category 124, e.g., to predict event occurrence. This may be used, for instance, by the digital content control module 126 to control output of digital content 118 as previously described. In this way, a combination of survival analysis and classification techniques may be used to overcome limitations of conventional techniques, and thus improve a user experience as well as operational efficiency of computing devices that employ these techniques.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Survival Analysis and Classification

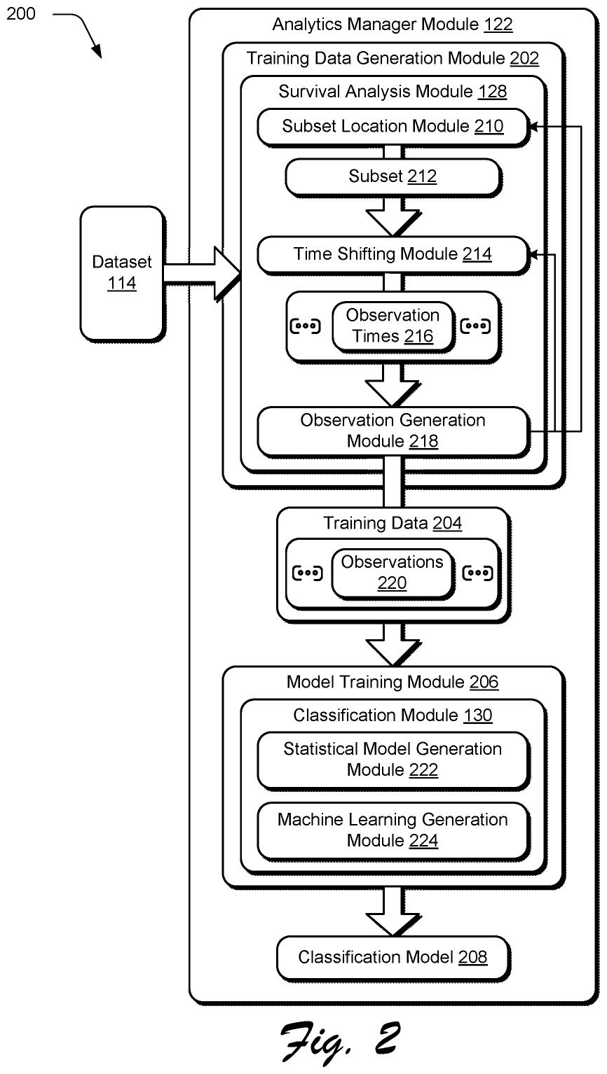

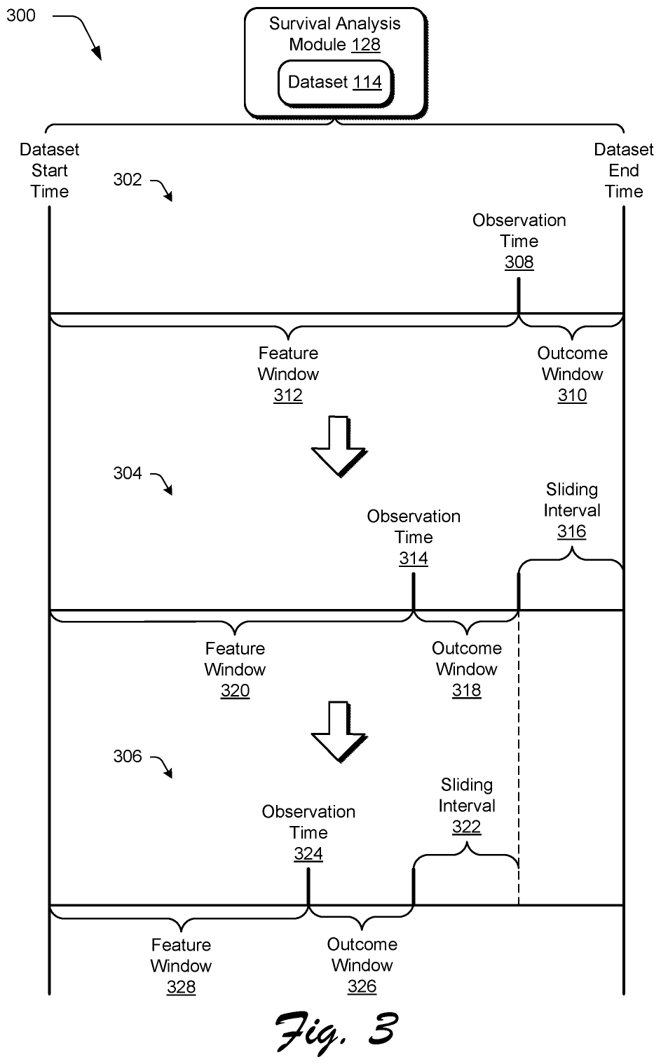

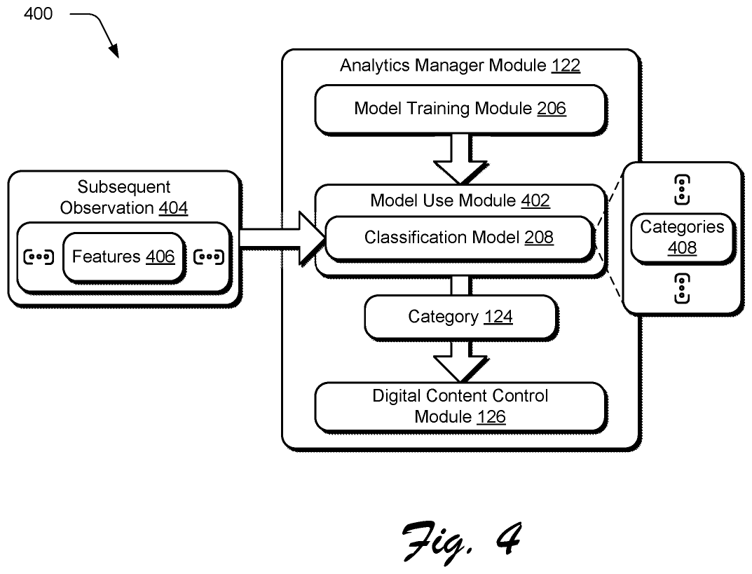

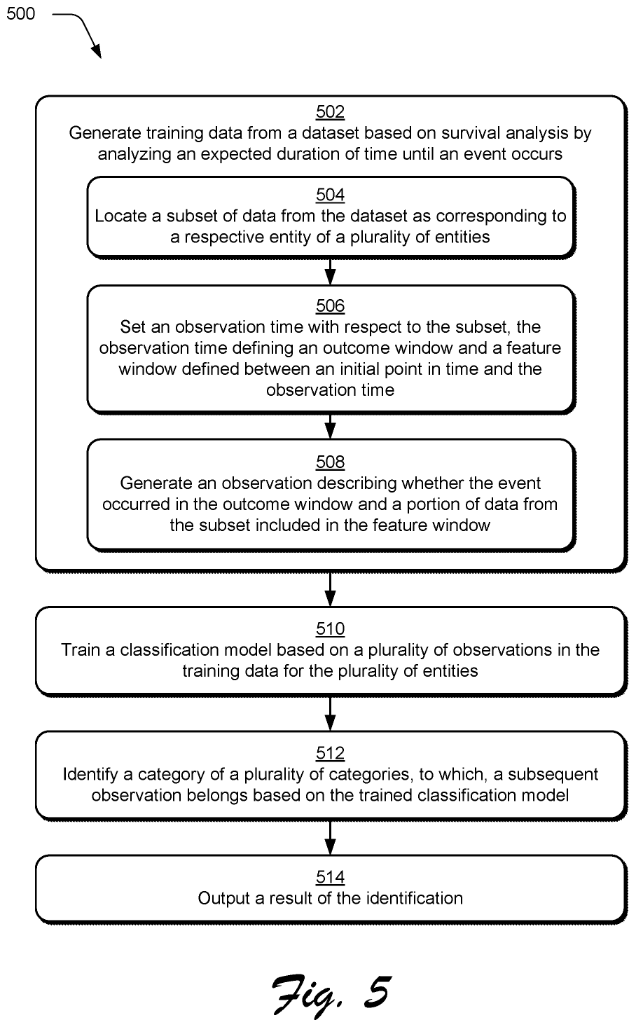

FIG. 2 depicts a system 200 in an example implementation showing operation of the survival analysis module 128 and the classification module 130 of the digital analytics system 104 of FIG. 1 in greater detail as generating training data to train a classification module. FIG. 3 depicts an example implementation 300 of generation of training data as a plurality of observations using a survival analysis technique of the survival analysis module 128 of FIG. 2. FIG. 4 depicts a system 400 in an example implementation in which the training data generated by the system 200 of FIG. 2 using survival analysis is used to train a classification model to classify a subsequent observation into a respective one of a plurality of categories as predicting occurrence of an event. FIG. 5 depicts a procedure 500 in an example implementation in which a survival analysis technique is used to generate a plurality of observations which are then used to train a classification module to classify a subsequent observation to a respective one of a plurality of categories.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 1-5.

User behavior is dynamic and constantly changing, and thus these characteristics make predicting occurrence of a future event difficult using conventional classification techniques, alone. Further, a vast amount of heterogeneous data may be available, which can span multiple years and relate to different aspects of user interaction. Conventional survival analysis techniques, however, are not suitable to address the multitude of covariates in this data and thus also fail in making a prediction when confronted with “big data.” In the following techniques, however, a combination of survival analysis and classification is used to overcome these challenges to increase accuracy and efficiency in computational resource consumption in prediction generation using “big data” that is not possible in conventional techniques.

To begin, a dataset 114 is received by the analytics manager module 122, e.g., from a service provider system 102 and/or directly from a client device 106. The dataset 114 is used by the analytics manager module 122 through a combination of survival analysis and classification to generate a model used to predict occurrence of an event by a respective entity, e.g., a user of the client device 106, operation of the client device 106 itself, and so forth. The dataset 114 includes an embedded time dimension that references features (explanatory variables) observed over time until occurrence of an event. The features, for instance, may describe the entity, event, characteristics of the events and entity, and so forth.

To support both survival analysis and classification, a training data generation module 202 is used to generate training data 204 based on survival analysis by analyzing an expected duration of time until an event occurs (block 502) in the dataset 114. This training data is then used by a model training module 206 to train a classification model 208 to implement classification techniques. Thus, the analytics manager module 122 is configured to implement both survival analysis and classification as part of predicting occurrence of an event.

As part of survival analysis by the survival analysis module 128, a subset location module 210 is employed to locate a subset 212 of data from the dataset as corresponding to a respective entity of a plurality of entities (block 504). The dataset 114, for instance, may correspond to respective entities, which are identified in the dataset using respective Entity IDs, e.g., User IDs. Therefore, location of the subset 212 may be performed by locating entries in the dataset 114 as corresponding to the respective Entity IDs.

A time shifting module 214 is then used by the survival analysis module 128 to set and shift observations times 216. An observation time 216 defines an outcome window and a feature window that is used as a basis to generate an observation (block 506). The outcome window is a window, within which, occurrence of the event is monitored by the observation generation module 218. This window is used to generate a response variable for an observation, e.g., whether the event did or did not occur. The outcome window defines a fixed amount of time after the observation time. The width (i.e., amount of time) may be predefined, e.g., based on how far into the future the event is to be predicted. For example, the outcome window may be set to thirty days to predict whether an event is to occur within the next thirty days.

The feature window is a window defined from a start time in the subset 212 to the observation time, within which, the features (explanatory variables) are generated for an observation. In other words, the feature window defines the available data in the subset 212 that is available for an entity before the observation time that is usable to generate features that are a basis of the observations.

In one example, the survival analysis module 128 begins by setting an initial observation time 216 within the subset 212. An outcome window is set with respect to the observation time 216. The amount of time defined for the outcome window defines a fixed amount of time after the observation time 216. A feature window is also set based on the initial observation time 216, such as to include data from the subset 212 that is between a start point of the subset 212 and the observation time 216. The feature window thus describes features as to “what has occurred before” the outcome window.

The observation generation module 218 is then configured to generate an observation 220 based on the feature window and the outcome window. The observation 220, for instance, may indicate whether the event occurred in the outcome window and include features taken from the feature window.

Additional observations are then generated by the survival analysis module 128 by shifting the observation times by the time shifting module 214. This causes changes to the outcome window and the feature window, which are then used to generate respective observations 220. This process may be repeated for respective entities in the dataset 114 to generate the training data 204.

FIG. 3 depicts an example implementation 300 of generation of training data 204 as a plurality of observations 220 using a survival analysis technique of the survival analysis module 128 of FIG. 2. This example implementation 300 is illustrated using first, second, and third stages 302, 304, 306 and describes an entity as a user and an event as a user action. It should be readily apparent that other entities (e.g., devices) and events (e.g., device actions) are also contemplated.

At the first stage 302, the survival analysis module 128 sets an initial observation time 308. The initial observation time 308 is specified as using a predefined width, i.e., an amount of time, which is this instance is defined in relation to an end time of the dataset 114. This initial observation time 308 defines an outcome window 310 that is to be analyzed for occurrence of an event. The initial observation time 308 also defines a feature window 312 between a start time of the dataset 114 and the initial observation time 308.

An observation is then generated for the first stage 302 by the survival analysis module 128 based on the first outcome window 310 and the feature window 312. The observation, for instance, may include a term indicating whether the event occurred within the outcome window 310. The observation may also include a term describing features includes in the feature window 312 before the observation time 308.

This technique may then continue to generate additional observations by shifting the observation time. As shown at the second stage 304, for instance, the observation time 314 is shifted by a sliding interval 316. This causes redefinition of an outcome window 318 and a feature window 320. As before, an observation is then generated based on the shifted observation time 314 that includes a term indicating whether the event occurred within the outcome window 318. The observation may also include a term describing features included in the feature window 320 before the shifted observation time 314.

As shown at the third stage 306, the observation time 324 is shifted by a sliding interval 322. This again causes redefinition of an outcome window 326 and a feature window 328. An observation is then generated based on the shifted observation time 324 that includes a term indicating whether the event occurred within the outcome window 326. The observation may also include a term describing features included in the feature window 328 before the shifted observation time 324. This technique continues as long as the validation conditions remain true as further described below, i.e., there is sufficient amounts of data within the dataset to set the observation time 308 to include valid outcome and feature windows.

Expressed another way, let d₀ be the data start time; d_{T} be the data end time; l be the outcome window width; and s be the sliding interval width. Also, let Eⱼ be the time user j enters the system; Lⱼ be the time user j leaves the system (Lⱼ=∞ if user j is still in the system as of now). Let dᵢⱼ be the ith observation time for user j.

To ensure dᵢⱼ is a valid observation time; i.e., feature window and outcome window exist for user j and dᵢⱼ, a set of conditions is checked at each observation time, which includes the following:

$$\begin{matrix}{d}_{ij} > {d}_{0} \\ {d}_{ij} < {L}_{j} \\ {d}_{ij} > {E}_{j}\end{matrix} Validation conditions$$

Multiple observations 220 for user j may be generated by the survival analysis module 128, examples of which are described as follows.

A first observation time for user j is set as d₁ⱼ=d_{T}−l. If d₁ⱼ is valid, then based on the feature window and outcome window defined by d₁ⱼ, an observation (X₁ⱼ, Y₁ⱼ) is generated where X₁ᵢ is based on a portion of the subset 212 using the data in the feature window and Y₁ⱼ is generated based on the response in the outcome window. Thus, a first term of the observation is based on a portion of the subset 212 that corresponds to the feature window and a second term of the observation is based on whether the event occurred in the outcome window. Validation conditions are checked above, and if no longer valid this technique is ceased.

The previous observation time dᵢⱼ is then shifted by the predefined sliding interval, to set another observation time for user j as d₍ᵢ₊₁ⱼ₎=dᵢⱼ−s. If d₍ᵢ₊₁₎ⱼ is valid, another observation is generated. Validation conditions are checked above, and if no longer valid this technique is ceased. This technique is continued as long as validations conditions are true. If not, another entity is selected and this technique is repeated, e.g., for each entity in the dataset 114 to generate the training data 204.

The training data 204 and included observations 220, once generated, are the passed from the training data generation module 202 to the model training module 206. The model training module 206 implements a classification module 130 to train a classification model 208 based on the plurality of observations in the training data for the plurality of entities (block 510). A classification model 208 is configured to classify an observation into a respective one of a plurality of categories. The classification model 208, for instance, may output probabilities that the observation is included within a respective category. When used in predicting occurrence of an event, the categories may include determining probabilities that an event will or will not occur using respective binary categories, which event is likely to occur in multiclass classification, and so on.

A variety of techniques may be employed to generate the classification model 208. A statistical model generation module 22 is representative of functionality of the classification module 130 to form the classification model 208 as a statistical model, e.g., using linear classifiers, regression techniques, quadratic classifiers, and so forth.

A machine learning generation module 224 is representative of functionality of the classification module 130 to form the classification model 208 as a machine learning model using machine learning techniques, such as neural network, decision trees, and so forth. A machine learning model refers to a computer representation that can be tuned (e.g., trained) based on inputs to approximate unknown functions. In particular, a machine learning model can include a model that utilizes algorithms to learn from, and make predictions on, known data by analyzing the known data to learn to generate outputs that reflect patterns and attributes of the known data. For instance, a machine learning model can include but is not limited to, decision trees, support vector machines, linear regression, logistic regression, Bayesian networks, random forest learning, dimensionality reduction algorithms, boosting algorithms, artificial neural networks, deep learning, and so forth. Thus, a machine learning model makes high-level abstractions in data by generating data-driven predictions or decisions from the known input data.

For example, a machine learning model may be trained as a classification model 208 using the training data 204 and included observations to make a prediction about occurrence of a subsequent event. As shown in the example system of FIG. 4, for instance, the classification model 208, once trained, is passed from a model training module 206 to a model use module 402. The model use module 402 receives a subsequent observation 404 including corresponding features 406. Using the trained classification model 208, a respective category 124 is identified from a plurality of categories 408, to which, the subsequent observation 404 belongs (block 512). A result of the identification is then output (block 514), e.g., to control subsequent output of digital content 118, for display in a user interface, and so forth. In this way, the techniques described herein may address a wide range of covariate data as part of a survival analysis and classification for a wide range of device and user action prediction scenarios, which is not possible using conventional techniques.

In order to incorporate varied data into the techniques described herein in a scalable manner, a standardized data model may be employed by the digital analytics system 104 to address varied types of data which may be included in a dataset 114. This promotes an ability of the techniques described herein to address “big data” (e.g., in terms of both volume and variety) as input for accurate predictions. Once the behavior event data is standardized according to the model, a framework of the analytics manager module as employing the survival analysis module 128 and classification module 130 supports a standardized set of features for the events in an efficient, automatic, and intuitive manner even for new data types.

The standard data model for the event data is defined as a schema with a set number (seven) of fields. Examples of field definitions include the following:
UserID: unique identified of the user;
EventTime: the timestamp at which the event happens;
RecordTime: the timestamp at which the event is recorded;
EventType: the type of the event, some examples are page visit, click, purchase, app launch, and so on;
EventSubType: the subtype of the event if any;
EventProperty: extra information regarding the events, which is stored as JSON string; and
Product: a product, to which, the event pertains.
   In the above example, the standard data model is generalized such that different types and highly heterogenous user behavioral data may be expressed. This includes, but is not limited to, website visitation behaviors, in-app usage behaviors, service usage behaviors, and offline behaviors. A variety of other device examples that do not involve a user are also contemplated as previously described.

Example System and Device

FIG. 6 illustrates an example system generally at 600 that includes an example computing device 602 that is representative of one or more computing systems and/or devices that may implement the various techniques described herein. This is illustrated through inclusion of the analytics manager module 122 including the survival analysis module 128 and the classification module 130. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium analytics environment, a method implemented by at least one computing device, the method comprising:
generating, by the at least one computing device, training data from a dataset based on survival analysis, the generating including:
locating a subset of data from the dataset as corresponding to a respective entity of a plurality of entities;
setting an observation time with respect to the subset, the observation time defining an outcome window and a feature window defined between an initial point in time and the observation time;
generating an observation describing whether the event occurred in the outcome window and a portion of data from the subset included in the feature window;
training, by the at least one computing device, a classification model based on a plurality of said observations in the training data for the plurality of entities;
identifying, by the at least one computing device, a category of a plurality of categories, to which, a subsequent observation belongs based on the trained classification model; and
outputting, by the at least one computing device, a result of the identifying.

2. The method as described in claim 1, wherein the feature window defined between a start or end point in the subset and the observation time.

3. The method as described in claim 1, wherein the generating is performed for the plurality of said observations by shifting the observation time and repeating the generating of the observation based on the shifted observation time.

4. The method as described in claim 3, wherein the shifting is based on a sliding interval that describes a defined amount of time based on an amount of time specified for the outcome window.

5. The method as described in claim 1, wherein the plurality of categories is based on the occurrence of the event.

6. The method as described in claim 5, wherein a first said category indicates the event has occurred and a second said category indicates the event has not occurred.

7. The method as described in claim 1, wherein the trained classification model is a statistical model.

8. The method as described in claim 1, wherein the training is performed using machine learning.

9. In a digital medium analytics environment, a system comprising:
a training data generation module implemented at least partially in hardware of a computing device to generate training data from a dataset based on survival analysis, the training data generation module including:
a subset location module to locate a subset of data from the dataset as corresponding to a respective entity of a plurality of entities;
a time shifting module to shift an observation time within the subset, the observation time defining an outcome window and a feature window; and
an observation generation module to generate a plurality of observations, the plurality of observations based on the shift in observation time and describing whether the event occurred in the outcome window and a portion of data from the subset included in the feature window for a respective said observation;
a model training module implemented at least partially in hardware of the computing device to generate a classification model using machine learning based on the plurality of observations in the training data for the plurality of entities.

10. The system as described in claim 9, wherein the classification model is configured to determine which of a plurality of categories corresponds to a subsequent observation.

11. The system as described in claim 10, wherein a first said category indicates the event has occurred and a second said category indicates the event has not occurred.

12. The system as described in claim 9, wherein the shifting of the observations times by the time shifting module is based on a sliding interval that describes a defined amount of time used to shift the observation times.

13. The system as described in claim 12, wherein the defined amount of time corresponds to an amount of time specified for the outcome window.

14. In a digital medium analytics environment, a system comprising:
means for receiving data describing an observation; and
means for classifying the observation into a respective category of a plurality of categories using a classification model, the classification model trained using training data generated from a dataset based on survival analysis by analyzing an expected duration of time until an event occurs, the generation of the training data including:
locating a subset of data from the dataset as corresponding to a respective entity of a plurality of entities;
setting an observation time with respect to the subset, the observation time defining an outcome window and a feature window; and
generating an observation of a plurality of observation, the generated observation describing whether the event occurred in the outcome window and a portion of data from the subset included in the feature window.

15. The system as described in claim 14, wherein the classification model is configured to determine which of a plurality of categories corresponds to a subsequent observation.

16. The system as described in claim 15, wherein a first said category indicates the event has occurred and a second said category indicates the event has not occurred.

17. The system as described in claim 14, wherein the generating is performed for the plurality of said observations by shifting the observation time and repeating the generating of the observation based on the shifted observation time.

18. The system as described in claim 17, wherein the shifting is based on a sliding interval that describes a defined amount of time.

19. The system as described in claim 18, wherein the defined amount of time corresponds to an amount of time specified for the outcome window.

20. The system as described in claim 14, wherein the event involves operation of a device.
